(19) United States
(12) Patent Application Publication
(10) Pub. No.: US 2025/0362455 A1
(43) Pub. Date: Nov. 27, 2025

(54) CASCADING ARRANGEMENT OF SLOT WAVEGUIDE-BASED BRAGG GRATING FILTERS IN DEMULTIPLEXING APPLICATIONS

(71) Applicant: Cisco Technology, Inc., San Jose, CA (US)

(72) Inventors: Tao LING, Breinigsville, PA (US); Ravi S. TUMMIDI, Breinigsville, PA (US); Shiyi CHEN, Breinigsville, PA (US)

(21) Appl. No.: 18/674,720

(22) Filed: May 24, 2024

(51) Int. Cl. G02B 6/293; G02B 6/42

(52) U.S. Cl. CPC G02B 6/2938; G02B 6/29316; G02B 6/4215

(57) ABSTRACT

An optical apparatus is described that includes an input port configured to receive an optical signal comprising a plurality of wavelengths, a plurality of output ports, and one or more grating filters arranged between the input port and the plurality of output ports. Each grating filter is configured to receive one or more wavelengths of the plurality of wavelengths at a multimode waveguide, to propagate the one or more wavelengths through a first transition section extending between the multimode waveguide and a slot waveguide, and to reflect, using a respective antisymmetric Bragg grating formed in the slot waveguide, a first mode of a respective wavelength of the one or more wavelengths through the first transition section toward a respective output port of the plurality of output ports.

### TECHNICAL FIELD

Embodiments presented in this disclosure generally relate to optical filtering and demultiplexing, and more specifically, to wavelength division multiplexing (WDM) using a cascading arrangement of slot waveguide-based Bragg grating filters.

### BACKGROUND

WDM schemes support multiple channels through a light-carrying medium, such as an optical waveguide or an optical fiber. WDM schemes are typically distinguished by the spacing between wavelengths. For example, a “normal” WDM system supports 2 channels spaced apart by 240 nanometers (nm), a coarse WDM (CWDM) system supports up to eighteen (18) channels that are spaced apart by 20 nm, and a dense WDM (DWDM) system supports up to eighty (80) channels that are spaced apart by 0.4 nm. Due to the wavelength spacing, a CWDM system tends to be more tolerant than a DWDM system and does not require high-precision controlled laser sources. As a result, a CWDM system tends to be less expensive and consumes less power.

CWDM-based optical transceiver modules often include an on-chip integrated optical multiplexer/demultiplexer (“mux, de-mux” or “MDM”). A low-loss implementation of the optical MDM is preferred for efficient operation and low cost of the optical transceiver module. High-quality silicon nitride (SiN) films have become more common in high-performance optical devices (such as optical MDMs) due to their compatibility with CMOS processes, ease of deposition on different substrates, low loss, and low thermal sensitivity. However, due to variations in fabrication processes, the thickness of the SiN films can vary significantly (e.g., up to ±10%), which impacts performance of the optical devices and may require adjustments to the architecture of the optical devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a diagram of an exemplary optical apparatus, according to one or more embodiments.

FIGS. 2 and 3 are diagrams of exemplary silicon-on-insulator (SOI) based optical waveguides, according to one or more embodiments.

FIG. 4 is a diagram of an exemplary slot waveguide-based grating filter, according to one or more embodiments.

FIG. 5 is a diagram of exemplary implementations of a demultiplexer with a cascading arrangement of slot waveguide-based grating filters, according to one or more embodiments.

FIG. 6 is a diagram of exemplary implementations of a demultiplexer with mitigated crosstalk, according to one or more embodiments.

FIG. 7 includes graphs illustrating operation of the slot waveguide-based grating filters as bandpass filters, according to one or more embodiments.

FIG. 8 includes graphs illustrating operation of the slot waveguide-based grating filters as low-pass filters, according to one or more embodiments.

FIG. 9 includes a graph illustrating operation of the slot waveguide-based grating filters as bandpass filters having partially overlapping passbands, according to one or more embodiments.

FIG. 10 illustrates a method of demultiplexing using a cascading arrangement of slot waveguide-based grating filters, according to one or more embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an optical apparatus comprising an input port configured to receive an optical signal comprising a plurality of wavelengths, a plurality of output ports, and one or more grating filters arranged between the input port and the plurality of output ports. Each grating filter is configured to receive one or more wavelengths of the plurality of wavelengths at a multimode waveguide, to propagate the one or more wavelengths through a first transition section extending between the multimode waveguide and a slot waveguide, and to reflect, using a respective antisymmetric Bragg grating formed in the slot waveguide, a first mode of a respective wavelength of the one or more wavelengths through the first transition section toward a respective output port of the plurality of output ports.

In another embodiment, an optical apparatus comprises a plurality of receivers, and a demultiplexer comprising an input port configured to receive an optical signal comprising a plurality of wavelengths, a plurality of output ports, and a plurality of grating filters in a cascading arrangement. Each grating filter is configured to receive one or more wavelengths of the plurality of wavelengths at a multimode waveguide, to propagate the one or more wavelengths through a first transition section extending between the multimode waveguide and a slot waveguide, and to reflect, using a respective antisymmetric Bragg grating formed in the slot waveguide, a first mode of a respective wavelength of the one or more wavelengths through the first transition section toward a respective output port of the plurality of output ports.

In another embodiment, an optical grating filter comprises a first multimode waveguide configured to receive an optical signal comprising a plurality of wavelengths, a slot waveguide having an antisymmetric Bragg grating formed therein, and a first transition section between the first multimode waveguide and the slot waveguide. The first transition section is configured to propagate the plurality of wavelengths in a first propagation direction, and to propagate, in a second propagation direction, a reflected mode of a respective wavelength corresponding to a Bragg wavelength of the antisymmetric Bragg grating.

### Example Embodiments

The development of a fabrication-tolerant optical MDM increases fabrication yield and may further reduce the power consumption of the optical MDM during operation. Various implementations of an optical apparatus described herein use antisymmetric Bragg grating(s) formed in slot waveguide(s) to reduce the passband shift caused by changes in material thickness (such as those occurring with SiN films). This can reduce an effective index of the propagation mode, which makes the optical apparatus less sensitive to changes in material thickness.

In some embodiments, an optical apparatus comprises an input port configured to receive an optical signal comprising a plurality of wavelengths, a plurality of output ports, and one or more Bragg grating filters arranged between the input port and the plurality of output ports. Each Bragg grating filter is configured to receive one or more wavelengths of the plurality of wavelengths at a multimode waveguide, and propagate the one or more wavelengths through a first transition section extending between the multimode waveguide and a slot waveguide. Each Bragg grating filter is further configured to reflect, using a respective antisymmetric Bragg grating formed in the slot waveguide, a first mode of a respective wavelength of the one or more wavelengths through the first transition section toward a respective output port of the plurality of output ports.

In some embodiments, the one or more Bragg grating filters comprise a plurality of Bragg grating filters in a cascading arrangement. In some embodiments, the antisymmetric Bragg grating(s) are formed in slot waveguide(s) formed in a silicon photonic chip. The antisymmetric Bragg grating(s) may have various sidewall corrugation shapes, such as a rectangle shape, a sine shape, or a cosine shape.

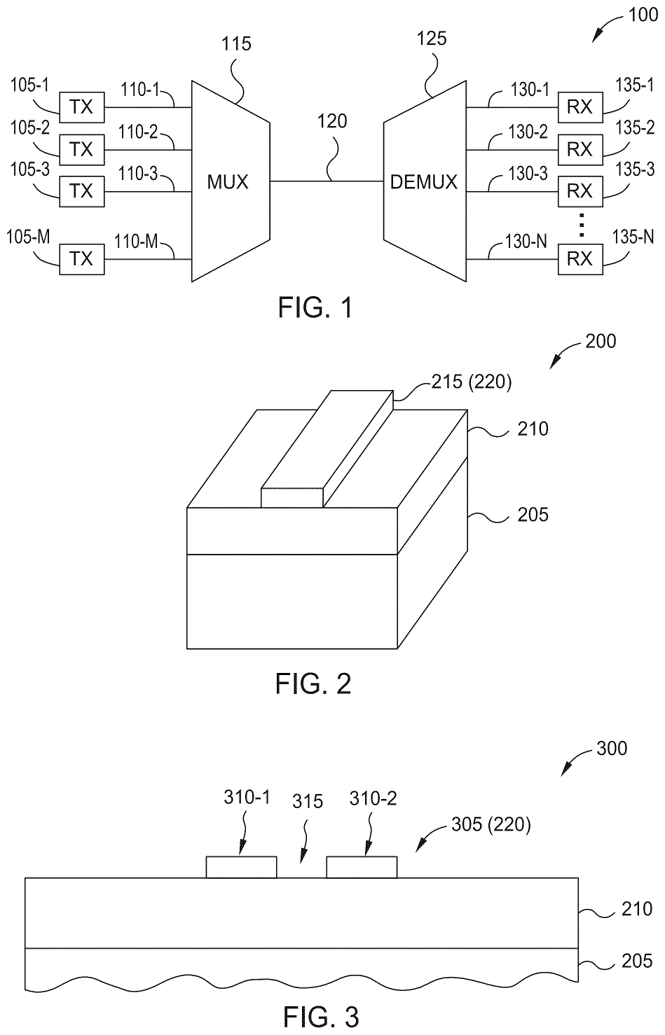

FIG. 1 is a diagram 100 of an exemplary optical apparatus, according to one or more embodiments. In some embodiments, the optical apparatus represents an optical MDM of an optical transceiver module, which in some cases may be integrated into a silicon photonic chip. Other implementations of the optical apparatus are also contemplated.

The optical apparatus comprises a plurality of transmitters 105-1, 105-2, 105-3, . . . , 105-M (generically or collectively, transmitter(s) 105) that provide optical signals via a respective plurality of optical links 110-1, 110-2, 110-3, . . . , 110-M (generically or collectively, optical link(s) 110) to a multiplexer 115. In some embodiments, each transmitter 105 comprises a laser source generating a respective optical signal (e.g., an unmodulated continuous wave (CW) optical signal) having a respective wavelength. The wavelengths of the optical signals may be selected according to a predefined multiplexing scheme, such as WDM, DWDM, or CWDM. Each transmitter 105 may further comprise an optical modulator configured to modulate the respective optical signal, and may further comprise circuitry for further processing of the respective optical signal. In some embodiments, the optical links 110 are optical waveguides formed in a silicon photonic chip. In other embodiments, the optical links 110 are optical fibers.

The multiplexer 115 combines the several optical signals into a multiplexed optical signal that is output onto an optical link 120. In some embodiments, the multiplexer 115 comprises a CWDM multiplexer, although implementations using other WDM schemes are also contemplated. In some embodiments, the optical link 120 is an optical waveguide formed in the silicon photonic chip. In other embodiments, the optical link 120 is an optical fiber.

A demultiplexer 125 is communicatively coupled with the multiplexer 115 via the optical link 120. The demultiplexer 125 demultiplexes the multiplexed optical signal transmitted by the optical link 120 into a plurality of optical signals. In some embodiments, the demultiplexer 125 comprises a CWDM demultiplexer, although other implementations are also contemplated. The plurality of optical signals is provided from the demultiplexer 125 via a respective plurality of optical links 130-1, 130-2, 130-3, . . . , 130-N (generically or collectively, optical link(s) 130) to a plurality of receivers 135-1, 135-2, 135-3, . . . , 135-N (generically or collectively, receiver(s) 135). In some embodiments, the optical links 130 are optical waveguides formed in the silicon photonic chip. In other embodiments, the optical links 130 are optical fibers. In some embodiments, each receiver 135 comprises an optical demodulator to demodulate the respective optical signal, and may further comprise circuitry for further processing of the respective optical signal.

In some embodiments, and as will be discussed in greater detail, the demultiplexer 125 comprises a plurality of antisymmetric Bragg gratings in a cascading arrangement. Beneficially, using the cascading arrangement provides the multiplexer 115 and/or the demultiplexer 125 with a relatively flat-top passband, and in some cases may be used to eliminate the temperature control on the laser source of the transmitters 105 and/or to reduce the power consumption of the optical apparatus. Further, the antisymmetric Bragg gratings may be capable of achieving very low insertion loss, such that the multiplexer 115 and/or the demultiplexer 125 has an insertion loss of less than 1-2 dB.

FIGS. 2 and 3 are diagrams 200, 300 of exemplary silicon-on-insulator (SOI) based optical waveguides, according to one or more embodiments. The features of the diagrams 200, 300 may be used in conjunction with other embodiments. For example, the multiplexer 115 and/or demultiplexer 125 of FIG. 1 may be implemented in a silicon photonic chip using the SOI structures illustrated in the diagrams 200, 300. It will be noted, however, that the multiplexer 115 and/or demultiplexer 125 may be implemented using different semiconductor fabrication technologies.

In some embodiments, a silicon substrate 205 comprises a bulk silicon (Si) substrate in which one or more features or materials for active optical device(s) to be produced (e.g., laser, detector, modulator, absorber) are pre-processed. The thickness of the silicon substrate 205 may vary depending on the specific application. For example, the silicon substrate 205 may be the thickness of a typical semiconductor wafer (e.g., 100-700 microns), or in some cases may be thinned and mounted on another substrate.

The diagrams 200, 300 each depict the silicon substrate 205, an insulator layer 210 disposed above the silicon substrate 205, and an optical waveguide 215 formed in a waveguide layer 220 disposed above the insulator layer 210. In some embodiments, the insulator layer 210 comprises a buried oxide (BOX) layer formed of silicon dioxide. As with the silicon substrate 205, the thickness of the insulator layer 210 may also vary depending on the application. In some embodiments, the thickness of the insulator layer 210 may range from less than one micron to tens of microns.

In some embodiments, the waveguide layer 220 is formed of a silicon nitride or silicon oxynitride material, e.g., as a film that is deposited on the insulator layer 210. As mentioned above, silicon nitride-based waveguides may offer compatibility with CMOS processes, ease of deposition on different substrates, low loss, and low thermal sensitivity. The thickness of the waveguide layer 220 may range from less than 100 nm to greater than a micron. More specifically, the waveguide layer 220 may be between 100-300 nm thick. In other embodiments, the waveguide layer 220 may be formed of other suitable semiconductor materials, such as elemental Si (e.g., monocrystalline or polycrystalline Si).

In the diagram 200, the optical waveguide is formed in the waveguide layer 220 as a ridge waveguide 215 (also referred to as a “wire waveguide”). In some embodiments, the dimensioning of the ridge waveguide 215 (e.g., width and height/thickness) supports the propagation of multiple optical modes at one or more wavelengths of an optical signal. Other types of optical waveguide formed in the waveguide layer 220 are also contemplated, such as a rib waveguide comprising a base portion disposed on the insulator layer 210, and a rib portion extending from the base portion.

In the diagram 300, the optical waveguide is formed in the waveguide layer 220 as a slot waveguide 305. The slot waveguide 305 comprises two strips 310-1, 310-2 that are spaced apart by a gap 315. The strips 310-1, 310-2 are generally implemented as high-index ridge waveguides, and the gap 315 is filled with a low-index material, such that the slot waveguide 305 confines propagation of an optical signal primarily in the strips 310-1, 310-2. Part of the optical mode may propagate in the gap 315. In some embodiments, the dimensioning of the slot waveguide 305 (e.g., the dimensioning of the strips 310-1, 310-2 and/or the gap 315) supports the propagation of multiple optical modes at one or more wavelengths of an optical signal.

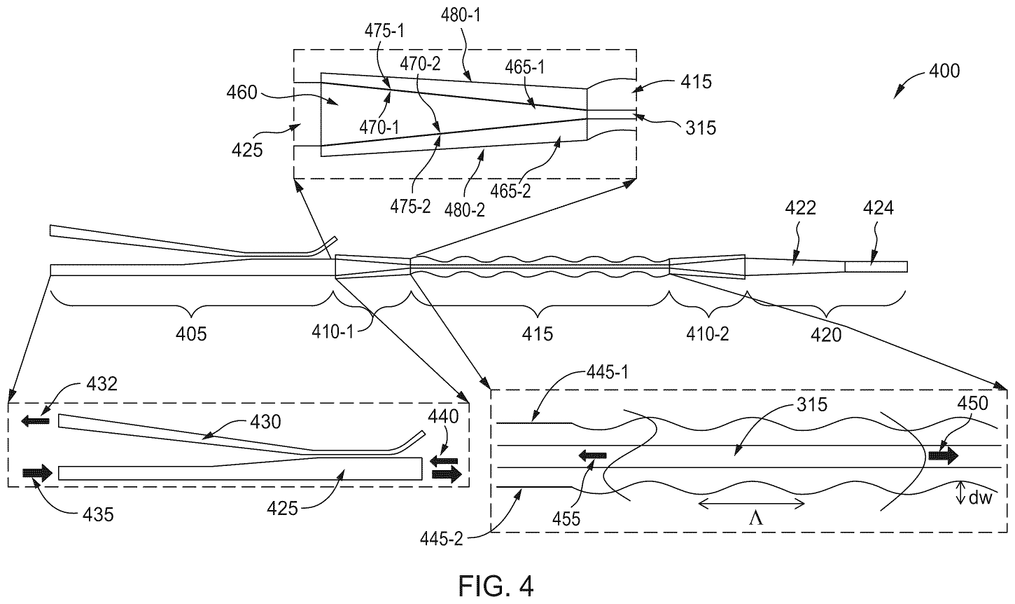

In some embodiments, grating patterns are formed (e.g., etched) along the sidewalls of the slot waveguide 305 (e.g., along the lateral sidewalls of the strips 310-1, 310-2) to form the antisymmetric Bragg gratings of the multiplexer 115 and/or demultiplexer 125. FIG. 4 is a diagram representing a top view of an exemplary slot waveguide-based grating filter 400, according to one or more embodiments. The features of the slot waveguide-based grating filter 400 may be used in conjunction with other embodiments. For example, the sidewall grating patterns may be implemented in the slot waveguide 305 to form an antisymmetric Bragg grating 415 that transmits a first mode at a particular wavelength of an optical signal, and reflects another mode at the wavelength.

As shown, the slot waveguide-based grating filter 400 comprises a mode multiplexer 405, a first transition section 410-1, the antisymmetric Bragg grating 415, a second transition section 410-2, and a multimode waveguide 420 arranged in series within the waveguide layer 220. A first arm 425 of the mode multiplexer 405 (e.g., implemented as a multimode waveguide) receives an optical signal comprising one or more wavelengths (e.g., a multiplexed optical signal comprising a plurality of wavelengths). A first wavelength of the received optical signal comprises a first mode 435 (e.g., a fundamental transverse electric (TE) mode) that is propagated through the first arm 425 to the first transition section 410-1.

The first transition section 410-1 comprises an inner section 460 having tapered edges 470-1, 470-2 that extend from the interface of the first transition section 410-1 with the first arm 425. Thus, the inner section 460 narrows from a width of the first arm 425 at the interface, to approximately a width of the gap 315 of the slot waveguide 305. The first transition section 410-1 further comprises outer sections 465-1, 465-2 that are arranged between the first arm 425 and the antisymmetric Bragg grating 415, where each of the outer sections 465-1, 465-2 is arranged opposite one of the tapered edges 470-1, 470-2 of the inner section 460. The outer sections 465-1, 465-2 may be spaced apart from the inner section 460 (e.g., by a small gap).

As shown, each of the outer sections 465-1, 465-2 extend to a line that extends through the interface of the first transition section 410-1 with the first arm 425. In this way, the first transition section 410-1 may be wider than the first arm 425. Each of the outer sections 465-1, 465-2 comprises a first tapered edge 475-1, 475-2 that is complementary to the corresponding tapered edge 470-1, 470-2 of the inner section 460 (in some cases, arranged in parallel with each other), and a second tapered edge 480-1, 480-2 that is disposed outward of the first tapered edge 475-1, 475-2. In some cases, the first tapered edges 475-1, 475-2 extend to the inner sidewalls of the strips 310-1, 310-2 of the slot waveguide 305, and the second tapered edges 480-1, 480-2 extend to the outer sidewalls of the strips 310-1, 310-2.

The second transition section 410-2 may be constructed similarly to the first transition section 410-1, and provided with an opposite orientation. Thus, in some embodiments, the narrow end of the inner section 460 of the second transition section 410-2 (e.g., the apex of the triangle shape) may be arranged at the gap 315 of the slot waveguide 305, and the wide end of the inner section 460 (e.g., the base of the triangle shape) may be arranged at the interface with the multimode waveguide 420.

The multimode waveguide 420 may have any suitable implementation. In some embodiments, the multimode waveguide 420 comprises a multimode-to-single mode transition 422 and a single mode waveguide 424. The width of the multimode-to-single mode transition 422 reduces between the second transition section 410-2 (e.g., tapered edges) and the single mode waveguide 424 to provide the transition.

The antisymmetric Bragg grating 415 comprises sidewalls 445-1, 445-2 (e.g., the lateral sidewalls of the strips 310-1, 310-2) that have a grating pattern with a corrugation period ∧ and a depth dw. Although the sidewalls 445-1, 445-2 are shown as having a sine shape, alternate shapes of the grating pattern such as a cosine shape, a square shape, etc. are also contemplated.

The grating pattern may be formed, e.g., by deep etching into an edge of the slot waveguide 305 to create the periodic grating pattern along the length of the slot waveguide 305. As shown, the antisymmetric Bragg grating 415 transmits a first mode 450 (e.g., a fundamental TE mode) and reflects a second mode 455 (e.g., a first-order TE mode) toward the mode multiplexer 405. In another case, the antisymmetric Bragg grating 415 transmits a first-order TE mode as the first mode 450 and reflects a fundamental TE mode as the second mode 455 toward the mode multiplexer 405.

The second mode 455 is received by the first arm 425 of the mode multiplexer as mode 440, and is coupled into a second arm 430 of the mode multiplexer 405. Coupling the received mode 440 (e.g., a first-order TE mode) into the second arm 430 operates to convert the first-order TE mode to a fundamental TE mode 432. Other implementations of the mode multiplexer 405 are also contemplated, such as antisymmetric Y-junction mode multiplexers, on-resonance and off-resonance switching rings, and so forth.

As discussed above, the slot waveguide 305 used to form the antisymmetric Bragg grating 415 may be disposed in a waveguide layer 220 comprising a silicon nitride or silicon oxynitride material. In some embodiments, the silicon nitride or silicon oxynitride material may be deposited above a silicon oxide layer and the slot waveguide 305 (and the grating patterns) is formed using a dry etching process. Both silicon nitride and silicon oxynitride have thermo-optic coefficients smaller than that of elemental silicon, which results in the antisymmetric Bragg grating 415 (and the slot waveguide-based grating filter 400) being less sensitive to temperature variations during operation. In some cases, the lower temperature sensitivity means that no thermal tuning of the slot waveguide-based grating filter 400 is required during operation.

By using the slot waveguide 305, the effective index of the propagation mode is reduced and the optical mode extends further into the surrounding oxide cladding. Although reduction of the effective index may appear counterintuitive, this configuration makes the slot waveguide-based grating filter 400 less sensitive to the thickness variations of the waveguide layer 220, which improves or enables compatibility with certain materials, such as silicon nitride films. For example, simulated and experimental results show that the sensitive to thickness variations may be reduced by around 30%.

The grating patterns used to form the antisymmetric Bragg grating 415 may have any suitable alternate implementation. For example, in cases where the length of the antisymmetric Bragg grating 415 is sufficiently long (e.g., implemented within an optical fiber), the sidewall gratings may be spaced apart from each other (e.g., at different positions along the length of the antisymmetric Bragg grating).

Although the combination of the mode multiplexer 405 with the antisymmetric Bragg grating 415, as shown in FIG. 4, is used in various implementations of a demultiplexer, discussed below, to perform a demultiplexing function, it will be noted that the combination of the mode multiplexer 405 with the antisymmetric Bragg grating 415 may alternately be used to perform a multiplexing function. As a result, the combination of the mode multiplexer 405 with the antisymmetric Bragg grating 415 may be used in implementations of a multiplexer comprising a plurality of antisymmetric Bragg gratings in a cascading arrangement.

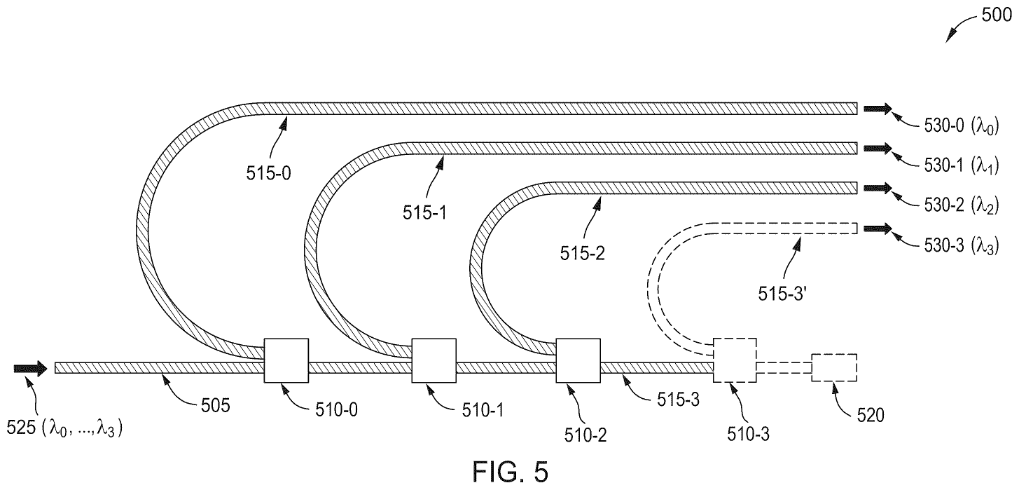

FIG. 5 is a diagram of exemplary implementations of a demultiplexer 500 with a cascading arrangement of antisymmetric Bragg gratings, according to one or more embodiments. The features illustrated in FIG. 5 may be used in conjunction with other embodiments. For example, the mode multiplexers and antisymmetric Bragg gratings included in the demultiplexer 500 may be configured as shown in FIG. 4.

The demultiplexer 500 comprises an input port 505 and a plurality of grating filters 510-0, 510-1, 510-2 (and in some embodiments 510-3). Each of the grating filters 510-0, 510-1, 510-2, 510-3 may represent a respective instance of the slot waveguide-based grating filter 400 of FIG. 4, with the corresponding antisymmetric Bragg grating of the grating filter 510-0, 510-1, 510-2, 510-3 having a different Bragg wavelength. In some embodiments, the grating filters 510-0, 510-1, 510-2, 510-3 in a cascading arrangement (which may alternately be referred to as a “serial” arrangement). Each of the grating filters 515-0, 515-1, 515-2, 515-3 has a Bragg wavelength at which one mode of a predetermined wavelength is reflected while at least one other mode of the predetermined wavelength is transmitted. Any other wavelengths of the optical signal are also transmitted by the grating filters 515-0, 515-1, 515-2, 515-3. For example, the grating filter 515-0 reflects a first-order mode of a first wavelength via a drop port, and transmits a fundamental mode of the first wavelength and at least one other wavelength via an output port toward the grating filters 510-1, 510-2, 510-3 that are downstream of the grating filter 510-0.

The grating filters 510-0, 510-1, 510-2, 510-3 may have any suitable filter responses for separating the mode of the respective wavelength for reflecting. In some embodiments, the grating filters 510-0, 510-1, 510-2, 510-3 are implemented as bandpass filters, which may have non-overlapping or partially overlapping passbands. For examples, the grating filters 510-0, 510-1, 510-2, 510-3 may have partially overlapping passbands with a center wavelength and an upper roll-off wavelength selected such that a range of the respective wavelength reflected by the grating filter 510-0, 510-1, 510-2, 510-3 is entirely included between the center wavelength and the upper roll-off wavelength. In other embodiments, the grating filters 510-0, 510-1, 510-2, 510-3 are implemented as low-pass filters and may have successively greater roll-off wavelengths.

In some embodiments, each of the grating filters 510-0, 510-1, 510-2, 510-3 further comprises a respective mode multiplexer that receives the wavelength reflected by a respective antisymmetric Bragg grating. Each mode multiplexer converts the mode of the reflected wavelength (e.g., a first-order TE mode) into a fundamental TE mode. Each mode multiplexer has an output that is coupled with a respective output port 515-0, 515-1, 515-2, 515-3 of the demultiplexer 500. In other embodiments, the plurality of mode multiplexers may be omitted, such that the antisymmetric Bragg gratings provide the reflected wavelengths (e.g., as a first order or higher mode) directly to the output ports 515-0, 515-1, 515-2, 515-3.

Thus, responsive to receiving an optical signal 525 comprising a plurality of wavelengths λ₀, λ₁, λ₂, λ₃ at the input port 505, the grating filter 510-0 reflects the wavelength λ₀ and transmits the remaining wavelengths λ₁, λ₂, λ₃. The mode multiplexer of the grating filter 510-0 receives the wavelength λ₀ and provides the wavelength λ₀ (with the mode converted to a fundamental mode) to the output port 515-0 as an optical signal 530-0. The grating filter 510-1 receives the wavelengths λ₁, λ₂, λ₃, reflects the wavelength λ₁, and transmits the remaining wavelengths λ₂, λ₃. The mode multiplexer of the grating filter 510-1 receives the wavelength λ₁ and provides the wavelength λ₁ (with the mode converted to a fundamental mode) to the output port 515-1 as an optical signal 530-1.

The grating filter 510-2 receives the wavelengths λ₂, λ₃, reflects the wavelength λ₂, and transmits the remaining wavelength λ₃. The mode multiplexer of the grating filter 510-2 receives the wavelength λ₂ and provides the wavelength λ₂ (with the mode converted to a fundamental mode) to the output port 515-2 as an optical signal 530-2.

In some embodiments, the remaining wavelength λ₃ is provided from the grating 510-2 to the output port 515-3 as an optical signal 530-3. The grating filter 510-2 represents a “last” grating in the cascading arrangement of the grating filters 510-0, 510-1, 510-2. Here, the grating filter 510-2 reflects a “second-to-last” wavelength (i.e., the wavelength λ₂) of the plurality of wavelengths λ₀, λ₁, λ₂, λ₃ toward the output port 515-2, and transmits a “last” wavelength (i.e., the wavelength λ₃) to the output port 515-3.

In other embodiments, the grating filter 510-3 receives the remaining wavelength λ₃ from the grating filter 510-2, and reflects the wavelength λ₃. The mode multiplexer of the grating filter 510-3 that receives the wavelength λ₃ and provides the wavelength λ₃ (with the mode converted to a fundamental mode) to the output port 515-3′ as the optical signal 530-3. In another embodiment, the mode multiplexer of the may be omitted. In some embodiments, the output of the grating 510-3 (e.g., a transmit port) is coupled with an optical absorber 520, such as a heavily-doped silicon waveguide. Beneficially, the optical absorber 520 mitigates reflections of optical signals, which can further improve the signal-to-noise ratio (SNR) of the optical signal 530-3. Here, the grating filter 510-3 represents a “last” grating in the cascading arrangement of the grating filters 510-0, 510-1, 510-2, 510-3. Here, the grating filter 510-3 reflects a “last” wavelength (i.e., the wavelength λ₃) of the plurality of wavelengths λ₀, λ₁, λ₂, λ₃ toward the output port 515-3′.

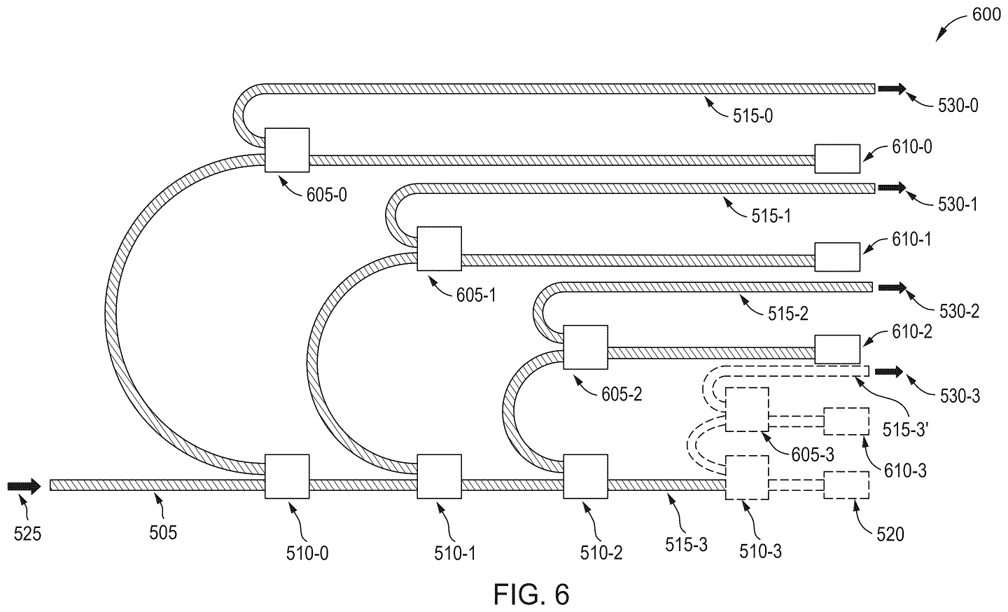

FIG. 6 is a diagram of exemplary implementations of a demultiplexer 600 with mitigated crosstalk, according to one or more embodiments. The features illustrated in FIG. 6 may be used in conjunction with other embodiments. For example, the mode multiplexers and antisymmetric Bragg gratings included in the demultiplexer 600 may be configured as shown in FIG. 4.

The demultiplexer 600 comprises the input port 505, the plurality of output ports 515-0, 515-1, 515-2, 515-3, a cascading arrangement of the grating filters 510-0, 510-1, 510-2 (and in some embodiments 510-3), and a plurality of mode multiplexers. The operation of the demultiplexer 600 is generally similar to that of the demultiplexer 500, discussed above.

The demultiplexer 600 further comprises a second plurality of grating filters 605-0, 605-1, 605-2 (and in some embodiments 605-3). Each of the grating filters 605-0, 605-1, 605-2, 605-3 receives a wavelength reflected by a respective grating filter 510-0, 510-1, 510-2, 510-3, and reflects the wavelength toward a respective output port 515-0, 515-1, 515-2, 515-3. Each of the grating filters 605-0, 605-1, 605-2, 605-3 comprises a respective mode multiplexer that receives the wavelength reflected by an antisymmetric Bragg grating of the grating filter 605-0, 605-1, 605-2, 605-3. Each mode multiplexer has an output that is coupled with a respective output port 515-0, 515-1, 515-2, 515-3. The demultiplexer 600 further comprises a plurality of optical absorbers 520, 610-0, 610-1, 610-2, 610-3. Each of the grating filters 605-0, 605-1, 605-2, 605-3 has an output coupled with a respective optical absorber 610-0, 610-1, 610-2, 610-3, each of which may be configured similarly to the optical absorber 520.

In some embodiments, the remaining wavelength λ₃ is provided from the grating 510-2 to the output port 515-3 as an optical signal 530-3. The grating filter 510-2 represents a “last” grating in the cascading arrangement of the grating filters 510-0, 510-1, 510-2. Here, the grating filter 510-2 reflects a “second-to-last” wavelength (i.e., the wavelength λ₂) of the plurality of wavelengths λ₀, λ₁, λ₂, λ₃ toward the output port 515-2 (e.g., through the grating filter 605-2), and transmits a “last” wavelength (i.e., the wavelength λ₃) to the output port 515-3.

In other embodiments, the grating filter 510-3 receives the remaining wavelength λ₃ from the grating filter 510-2, and reflects the wavelength λ₃. The mode multiplexer of the grating filter 510-3 that receives the wavelength λ₃ and transmits the wavelength λ₃ (with the mode converted to a fundamental mode) toward the output port 515-3′ (e.g., through the grating filter 605-3). In another embodiment, the mode multiplexer of the may be omitted. In some embodiments, the output of the grating 510-3 (e.g., a transmit port) is coupled with the optical absorber 520. Here, the grating filter 510-3 represents a “last” grating in the cascading arrangement of the grating filters 510-0, 510-1, 510-2, 510-3. Here, the grating filter 510-3 reflects a “last” wavelength (i.e., the wavelength λ₃) of the plurality of wavelengths λ₀, λ₁, λ₂, λ₃ toward the output port 515-3′.

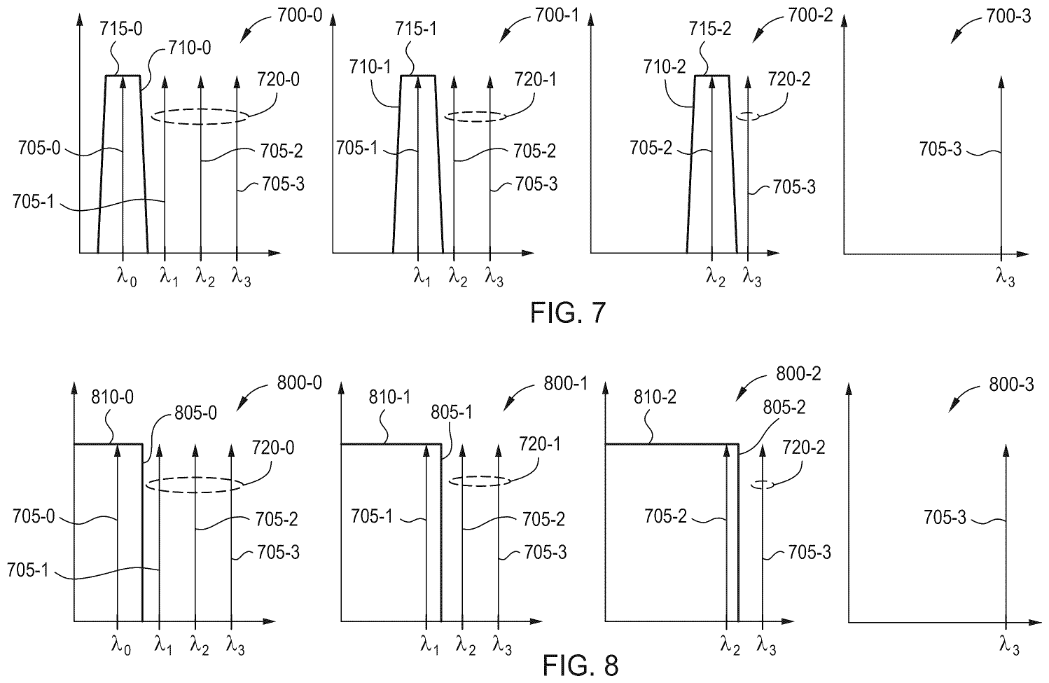

FIG. 7 are graphs 700-0, 700-1, 700-2, 700-3 illustrating operation of the grating filters as bandpass filters, according to one or more embodiments. The features illustrated in the graphs 700-0, 700-1, 700-2, 700-3 may be used in conjunction with other embodiments. For example, the cascading arrangement of grating filters in the demultiplexers 500, 600 may have antisymmetric Bragg gratings configured as bandpass filters. λ₃ discussed above, the antisymmetric Bragg gratings may have non-overlapping or partially overlapping passbands.

In the graph 700-0, the first grating in the cascading arrangement receives an optical signal comprising a plurality of signal components 705-0, 705-1, 705-2, 705-3 at a respective plurality of wavelengths λ₀, λ₁, λ₂, λ₃. A filter response 710-0 of the first grating includes a first passband 715-0, such that the signal component 705-0 (at the wavelength λ₀) is reflected by the first grating. The remaining wavelengths λ₁, λ₂, λ₃ (represented as a group 720-0 of the signal components 705-1, 705-2, 705-3) are transmitted by the first grating to a second grating in the cascading arrangement.

In the graph 700-1, the second grating receives the signal components 705-1, 705-2, 705-3 at the respective wavelengths λ₁, λ₂, λ₃. A filter response 710-1 of the second grating includes a second passband 715-1, such that the signal component 705-1 (at the wavelength λ₁) is reflected by the second grating. The remaining wavelengths λ₂, λ₃ (represented as a group 720-1 of the signal components 705-2, 705-3) are transmitted by the second grating to a third grating in the cascading arrangement.

In the graph 700-2, the third grating receives the signal components 705-2, 705-3 at the respective wavelengths λ₂, λ₃. A filter response 710-2 of the third grating includes a third passband 715-1, such that the signal component 705-2 (at the wavelength λ₂) is reflected by the third grating. The remaining wavelength λ₃ (represented as a group 720-2 of the signal component 705-3) is transmitted by the third grating.

The signal component 705-3 (at the wavelength λ₃) is illustrated in the graph 700-3. In some embodiments, the signal component 705-3 is transmitted by the third grating to an output port. In other embodiments, the signal components 705-3 is reflected by a fourth grating toward the output port. Although the graphs 700-0, 700-1, 700-2, 700-3 show one sequence of filtering the signal components 705-0, 705-1, 705-2, 705-3 using the cascading arrangement, other embodiments may have alternate sequences of filtering the signal components 705-0, 705-1, 705-2, 705-3.

FIG. 8 are graphs 800-0, 800-1, 800-2, 800-3 illustrating operation of the antisymmetric Bragg gratings as low-pass filters, according to one or more embodiments. The features illustrated in the graphs 800-0, 800-1, 800-2, 800-3 may be used in conjunction with other embodiments. For example, the cascading arrangement of grating filters in the demultiplexers 500, 600 may have antisymmetric gratings configured as low-pass filters.

In the graph 800-0, the first grating in the cascading arrangement receives the optical signal comprising the plurality of signal components 705-0, 705-1, 705-2, 705-3. A filter response 805-0 of the first grating includes a first passband 810-0, such that the signal component 705-0 (at the wavelength λ₀) is reflected by the first grating. The remaining wavelengths λ₁, λ₂, λ₃ are transmitted by the first grating to a second grating in the cascading arrangement.

In the graph 800-1, the second grating receives the signal components 705-1, 705-2, 705-3. A filter response 805-1 of the second grating includes a second passband 810-1, such that the signal component 705-1 (at the wavelength λ₁) is reflected by the second grating. The remaining wavelengths λ₂, λ₃ are transmitted by the second grating to a third grating in the cascading arrangement.

In the graph 800-2, the third grating receives the signal components 705-2, 705-3. A filter response 805-2 of the third grating includes a third passband 810-2, such that the signal component 705-2 (at the wavelength λ₂) is reflected by the third grating. The remaining wavelength λ₃ is transmitted by the third grating.

The signal component 705-3 (at the wavelength λ₃) is illustrated in the graph 800-3. In some embodiments, the signal component 705-3 is transmitted by the third grating to an output port. In other embodiments, the signal components 705-3 is reflected by a fourth grating toward the output port.

λ₃ shown, the passbands 810-0, 810-1, 810-2 are all partially overlapping with each other. However, other embodiments may include different combinations of passbands, which may include some passbands that are non-overlapping. For example, the cascading arrangement may include a combination of one or more gratings configured as low-pass filters and one or more gratings configured as bandpass filters. Further, gratings configured as high-pass filters are also contemplated, whether used in isolation or in combination with other types of filters.

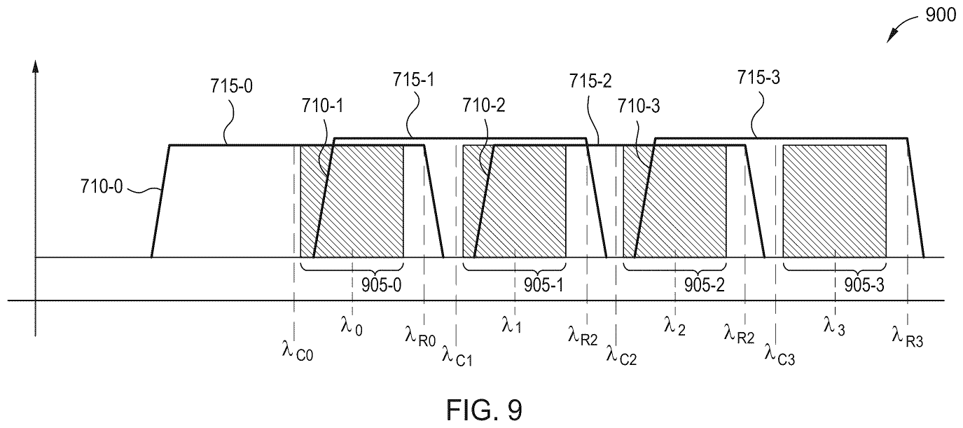

FIG. 9 is a graph 900 illustrating operation of the antisymmetric Bragg gratings as bandpass filters having partially overlapping passbands, according to one or more embodiments. The features illustrated in the graph 900 may be used in conjunction with other embodiments. For example, the cascading arrangement of grating filters in the demultiplexers 500, 600 may have antisymmetric Bragg gratings configured as bandpass filters.

The graph 900 illustrates the filter responses 710-0, 710-1, 710-2, 710-3 for the respective gratings. The filter responses 710-0, 710-1, 710-2, 710-3 include the partially overlapping passbands 715-0, 715-1, 715-2, 715-3. Each passband 715-0, 715-1, 715-2, 715-3 has a respective center wavelength λ_{C0}, λ_{C1}, λ_{C2}, λ_{C3} and a respective upper roll-off wavelength λ_{R0}, λ_{R1}, λ_{R2}, λ_{R3}. The center wavelengths λ_{C0}, λ_{C1}, λ_{C2}, λ_{C3} and the upper roll-off wavelengths λ_{R0}, λ_{R1}, λ_{R2}, λ_{R3} are selected such that ranges 905-0, 905-1, 905-2, 905-3 surrounding the respective wavelengths λ₀, λ₁, λ₂, λ₃ are entirely included between the center wavelengths λ_{C0}, λ_{C1}, λ_{C2}, λ_{C3} and the upper roll-off wavelengths λ_{R0}, λ_{R1}, λ_{R2}, λ_{R3}. Stated another way, a first grating is designed such that a range 905-0 surrounding a first wavelength λ₀ is entirely included between the center wavelength λ_{C0} and the upper roll-off wavelength λ_{R0}, a second grating is designed such that a range 905-1 surrounding a second wavelength λ₁ is entirely included between the center wavelength λ_{C0} and the upper roll-off wavelength λ_{R1}, and so forth. By accommodating the ranges 905-0, 905-1, 905-2, 905-3 in this manner, the partially overlapping passbands 715-0, 715-1, 715-2, 715-3 may be spaced closer together to have a greater amount of overlap while maintaining suitable selectivity of the gratings (i.e., to reflect one wavelength but not an adjacent wavelength) in the cascading arrangement.

In one non-limiting example of a CWDM scheme, four (4) lanes are defined such that the wavelength λ₀=1271 nm, the wavelength λ₁=1291 nm, the wavelength λ₂=1311 nm, and the wavelength λ₃=1331 nm. Each of the ranges 905-0, 905-1, 905-2, 905-3 is +6.5 nm of the respective wavelength λ₀, λ₁, λ₂, λ₃, such that the range 905-0 is 1264.5 nm to 1277.5 nm (corresponding to a total range of 13 nm), the range 905-1 is 1284.5 nm to 1297.5 nm, the range 905-2 is 1304.5 nm to 1317.5 nm, and the range 905-3 is 1324.5 nm to 1337.5 nm.

Assume that the center wavelength λ_{C0}=1264 nm, the center wavelength λ_{C1}=1284 nm, the center wavelength λ_{C2}=1304 nm, and the center wavelength λ_{C3}=1324 nm (corresponding to a channel spacing of 20 nm). λ₃ each of the gratings has a passband of 32 nm, the upper roll-off wavelength λ_{R0}=1280 nm, the upper roll-off wavelength λ_{R1}=1300 nm, the upper roll-off wavelength λR2=1320 nm, and the upper roll-off wavelength λ_{R3}=1340 nm.

In this way, the range 905-0 (1264.5 nm to 1277.5 nm) is entirely included between the center wavelength λ_{C0} (1264 nm) and the upper roll-off wavelength λ_{R0} (1280 nm) for the first grating, the range 905-1 (1284.5 nm to 1297.5 nm) is entirely included between the center wavelength λ_{C1} (1284 nm) and the upper roll-off wavelength λ_{R1} (1300 nm) for the second grating, and so forth.

Beneficially, by configuring the gratings to provide the passbands 715-0, 715-1, 715-2, 715-3 (FIGS. 7, 9) and the passbands 810-0, 810-1, 810-2 (FIG. 8) as relatively wide and flat-top passbands with a steep edge spectrum response, the demultiplexer tends to have greater tolerance for fabrication variations, material layer thickness variations, and/or temperature variations. Using a silicon nitride or silicon oxynitride material for the gratings further increases the tolerance for these variations.

While the above example is discussed in terms of partially overlapping passbands 715-0, 715-1, 715-2, 715-3 for bandpass filters, similar techniques may be used to space the passbands of low-pass filters closer together while maintaining a suitable selectivity. For example, the cut-off wavelengths of the low-pass filters may be selected such that a minimum margin (e.g., 2 nm) exists between the cut-off wavelength for a grating and the range surrounding the particular wavelength of the optical signal to be reflected by the grating.

Further, while the demultiplexers 500, 600 have been depicted as a 1-to-4 (1:4) demultiplexer having three (3) or four (4) antisymmetric Bragg gratings in a cascading arrangement, other configurations of the demultiplexers 500, 600 are also contemplated. For example, the demultiplexer 125 may include a larger or smaller number of antisymmetric Bragg gratings in the cascading arrangement, different filter responses for the antisymmetric Bragg gratings, and so forth.

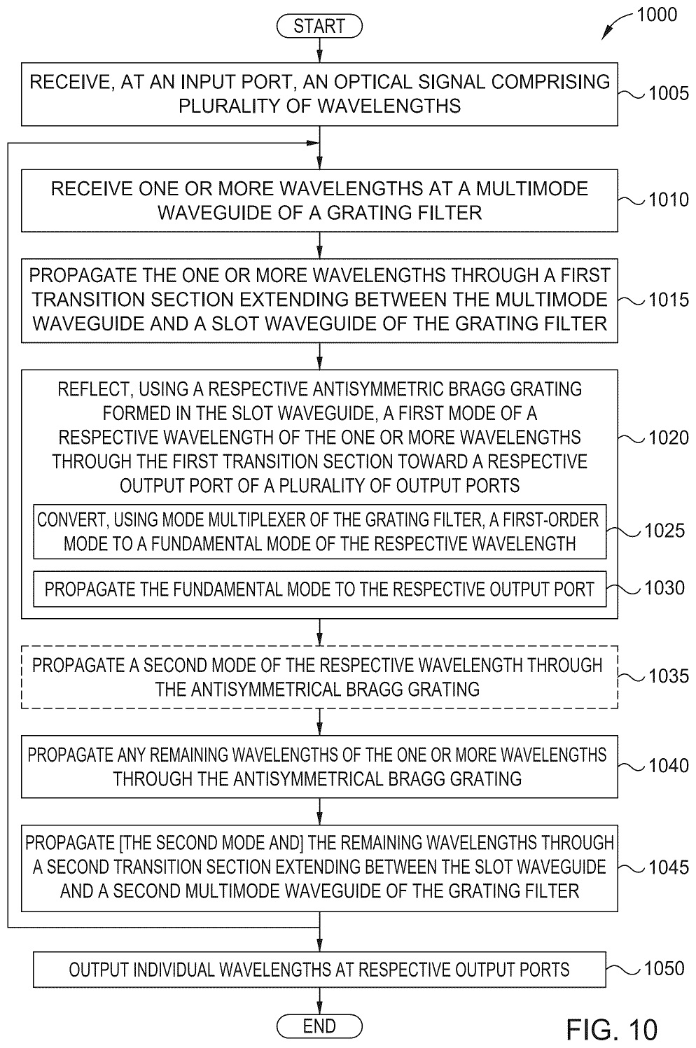

FIG. 10 illustrates a method 1000 of demultiplexing using a cascading arrangement of antisymmetric Bragg gratings, according to one or more embodiments. The method 1000 may be used in conjunction with other embodiments, e.g., performed using the demultiplexers 500, 600 described above.

The method 1000 begins at block 1005, where the demultiplexer receives, at an input port, an optical signal comprising a plurality of wavelengths. At block 1010, one or more wavelengths are received at a multimode waveguide of a grating filter of the demultiplexer. At block 1015, the one or more wavelengths propagate through a first transition section extending between the multimode waveguide and a slot waveguide of the grating filter.

At block 1020, a respective antisymmetric Bragg grating formed in the slot waveguide reflects a first mode of a respective wavelength of the one or more wavelengths through the first transition section toward a respective output port of a plurality of output ports. In some embodiments, reflecting the first mode comprises, at block 1025, converting, using a mode multiplexer of the grating filter, a first-order mode to a fundamental mode of the respective wavelength. In some embodiments, reflecting the first mode further comprises, at block 1030, propagating the fundamental mode to the respective output port.

At an optional block 1035, a second mode of the respective wavelength propagates through the antisymmetric Bragg grating. At block 1040, any remaining wavelengths of the one or more wavelengths propagate through the antisymmetric Bragg grating. At block 1045, the optional second mode and the remaining wavelengths propagate through a second transition section extending between the slot waveguide and a second multimode waveguide of the grating filter.

The method 1000 returns from block 1045 to block 1010 for each subsequent grating filter in the cascading arrangement. At block 1050, the individual wavelengths are output at respective output ports of the demultiplexer. The method 1000 ends following completion of block 1050.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An optical apparatus comprising:
an input port configured to receive an optical signal comprising a plurality of wavelengths;
a plurality of output ports; and
one or more grating filters arranged between the input port and the plurality of output ports, wherein each grating filter is configured to:
receive one or more wavelengths of the plurality of wavelengths at a multimode waveguide;
propagate the one or more wavelengths through a first transition section extending between the multimode waveguide and a slot waveguide; and
reflect, using a respective antisymmetric Bragg grating formed in the slot waveguide, a first mode of a respective wavelength of the one or more wavelengths through the first transition section toward a respective output port of the plurality of output ports.

2. The optical apparatus of claim 1, wherein the slot waveguide is formed of a silicon nitride or a silicon oxynitride material.

3. The optical apparatus of claim 1, wherein each grating filter is further configured to:
propagate a second mode of the respective wavelength through the antisymmetric Bragg grating; and
propagate any remaining wavelengths of the one or more wavelengths through the antisymmetric Bragg grating.

4. The optical apparatus of claim 3, wherein each grating filter is further configured to:
propagate the second mode and the remaining wavelengths through a second transition section extending between the slot waveguide and a second multimode waveguide.

5. The optical apparatus of claim 1, wherein the first mode of the respective wavelength is a first-order mode, the optical apparatus further comprising:
one or more mode multiplexers formed in the multimode waveguide, wherein each mode multiplexer is configured to:
convert the first-order mode to a fundamental mode of the respective wavelength; and
propagate the fundamental mode to the respective output port.

6. The optical apparatus of claim 1, wherein the one or more grating filters comprise a plurality of grating filters in a cascading arrangement.

7. The optical apparatus of claim 6, wherein the plurality of antisymmetric Bragg gratings, corresponding to the plurality of grating filters, have non-overlapping passbands.

8. The optical apparatus of claim 6, wherein the plurality of antisymmetric Bragg gratings, corresponding to the plurality of grating filters, have partially overlapping passbands.

9. The optical apparatus of claim 8, wherein each passband of the partially overlapping passbands has a center wavelength and an upper roll-off wavelength such that a range of the respective wavelength reflected by the respective antisymmetric Bragg grating is entirely included between the center wavelength and the upper roll-off wavelength.

10. An optical apparatus comprising:
a plurality of receivers; and
a demultiplexer comprising:
an input port configured to receive an optical signal comprising a plurality of wavelengths;
a plurality of output ports; and
a plurality of grating filters in a cascading arrangement, wherein each grating filter is configured to:
receive one or more wavelengths of the plurality of wavelengths at a multimode waveguide;
propagate the one or more wavelengths through a first transition section extending between the multimode waveguide and a slot waveguide; and
reflect, using a respective antisymmetric Bragg grating formed in the slot waveguide, a first mode of a respective wavelength of the one or more wavelengths through the first transition section toward a respective output port of the plurality of output ports.

11. The optical apparatus of claim 10, wherein the demultiplexer is a coarse wavelength division multiplexing (CWDM) demultiplexer.

12. The optical apparatus of claim 10, wherein the slot waveguide is formed of a silicon nitride or a silicon oxynitride material.

13. The optical apparatus of claim 10, wherein each grating filter is further configured to:
propagate a second mode of the respective wavelength through the antisymmetric Bragg grating; and
propagate any remaining wavelengths of the one or more wavelengths through the antisymmetric Bragg grating.

14. The optical apparatus of claim 13, wherein each grating filter is further configured to:
propagate the second mode and the remaining wavelengths through a second transition section extending between the slot waveguide and a second multimode waveguide.

15. The optical apparatus of claim 13, wherein the first mode of the respective wavelength is a first-order mode, the optical apparatus further comprising:
one or more mode multiplexers formed in the multimode waveguide, wherein each mode multiplexer is configured to:
convert the first-order mode to a fundamental mode of the respective wavelength; and
propagate the fundamental mode to the respective output port.

16. An optical grating filter comprising:
a first multimode waveguide configured to receive an optical signal comprising a plurality of wavelengths;
a slot waveguide having an antisymmetric Bragg grating formed therein; and
a first transition section between the first multimode waveguide and the slot waveguide, the first transition section configured to:
propagate the plurality of wavelengths in a first propagation direction; and
propagate, in a second propagation direction, a reflected mode of a respective wavelength corresponding to a Bragg wavelength of the antisymmetric Bragg grating.

17. The optical grating filter of claim 16, wherein the slot waveguide is formed of a silicon nitride or a silicon oxynitride material.

18. The optical grating filter of claim 16, further comprising:
a second multimode waveguide; and
a second transition section between the slot waveguide and the second multimode waveguide,
wherein the second multimode waveguide is configured to receive a propagated mode of the respective wavelength and any remaining wavelengths of the plurality of wavelengths.

19. The optical grating filter of claim 18, further comprising:
a mode multiplexer formed in the multimode waveguide, wherein the mode multiplexer is configured to:
convert the reflected mode to a fundamental mode of the respective wavelength; and
propagate the fundamental mode to an output port.

20. The optical grating filter of claim 19, wherein the reflected mode of the respective wavelength is a first-order mode.
